(19) United States
(12) Patent Application Publication
(10) Pub. No.: US 2007/0090052 A1
(43) Pub. Date: Apr. 26, 2007

(54) Chromatographic stationary phase

(76) Inventors: Alan D. Broske, West Chester, PA (US); Wu Chen, Newark, DE (US); Brian Bildingmeyer, Frazer, PA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/254,964

(22) Filed: Oct. 20, 2005

(51) Int. Cl. B01D 15/08; B01J 20/00

(52) U.S. Cl. 210/656; 502/407; 502/415; 428/402

(57) ABSTRACT

Provided is a composition of matter comprising a chromatographic stationary phase. The chromatographic stationary phase has bonded thereto, two different active silyl moieties. By combining two different active moieties on the same solid support, the activity of the chromatographic stationary phase can be tailored to a particular application. The active silyl moieties may be substituted or unsubstituted.

### BACKGROUND

Chromatography, for example liquid chromatography (LC), gas chromatography (GC) or supercritical fluid chromatography (SFC), is employed in both analytical and preparative methods to separate one or more species, e.g. chemical compounds, present in a carrier phase from the remaining species in the carrier phase. Chromatography is also employed, in a manner independent of separation of chemical species, as a method for analyzing purity of a chemical species, and/or as a means of characterizing a single chemical species. Characterization of a chemical species may comprise data, for example, a retention time for a particular chemical compound, when it is eluted through a particular chromatography column using specified conditions, e.g., carrier phase composition, flow rate, temperature, etc.

The carrier phase, often termed the “mobile phase,” for LC typically comprises water and one or more water-miscible organic solvents, for example, acetonitrile or methanol. The carrier phase for SFC typically comprises supercritical carbon dioxide and, optionally, one or more organic solvents that are miscible therewith, e.g., an alcohol. The species typically form a solution with the carrier phase. The carrier phase is typically passed through a stationary phase.

The rate at which a particular species in a carrier phase passes through a stationary phase depends upon the affinity of the species for the stationary phase. Species having a higher affinity for the stationary phase pass through at slower rates relative to species having lower affinity for the stationary phase.

Affinity of a species for a stationary phase results primarily from interaction of the species with chemical groups present on the stationary phase. Chemical groups may be provided on the stationary phase by reacting a surface-modifying reagent with a substrate, such as a silica substrate. Chemical groups attached to the surface of the substrate can modulate the rate at which different species pass through the chromatography column. Surface-modifying agents may be employed to install desired chemical groups onto the stationary phase. For example, a suitable stationary phase for separating an anionic species from a cationic species may be prepared using a surface-modifying reagent to attach a cationic chemical group to a substrate surface thereby forming a stationary phase having cationic groups.

Considerable research has been directed toward new stationary phase compositions for use in chromatography. There had remained, however, a need to provide such stationary phase compositions for chromatography which provide useful separation characteristics for particular types of species mixtures and also for broad application to chromatographic separations.

### SUMMARY

According to an embodiment of the invention, there is provided a chromatographic stationary phase composition comprising a solid support, ⊕ having bonded thereto at least one silyl moiety according to Formula I:
—O—Si(R¹)ₙ(X¹)ₘ Formula I
and at least one different silyl moiety according to Formula II:
—O—Si(R²)ₙ(X²)ₘ Formula II
wherein:
X¹ and X² are independently —(C₁-C₆)alkyl;
—O—Si represents an oxygen bond between the silane and the solid support;
n is 1;
m is 2; and
R¹ and R² are independently selected from the group consisting of substituted —(C₃-C₄₀)hydrocarbyl and unsubstituted —(C₆-C₄₀)hydrocarbyl, and —(C₂-C₅)alkylene-OC(═O)NR^{a}R^{b}, wherein
R^{a} is substituted or unsubstituted —(C₄-C₂₀)alkyl or substituted or unsubstituted —(C₁-C₄)alkylene-(C₆-C₁₀)aryl; and
R^{b} is —H or —(C₁-C₅)alkyl;
wherein the expression —(C₂-C₅)alkylene-OC(═O)NR^{a}R^{b} includes moieties wherein R^{a} and R^{b} are combined to form a ring inclusive of the nitrogen atom bound to R^{a} and R^{b}.

The molar ratio of the silyl group of Formula I to the silyl group of Formula II in the composition is from 1:99 to 99:1.

According to another embodiment of the invention is provided a method for producing a chromatographic stationary phase comprising reacting a solid support, ⊕, having reactive silanol groups thereon with a first silane compound according to Formula III:
Si(R¹)ₙ(X¹)ₘ(L)_{g} Formula III
and a second silane compound according to Formula IV:
Si(R²)_{n′}(X²)_{m′}(L)_{g} Formula IV
wherein:
R¹, R², X, n, m are as defined above; and
L is a reactive chemical group and g is 1.
The first silane and second silane are reacted with the solid support either concurrently or sequentially. The molar ratio of first silane to second silane reacted with the solid support is from 1:99 to 99:1. The chromatographic stationary phase recovered from the process comprises a solid support, ⊕, having bonded thereto a first silyl group according to Formula I and a second silyl group according to Formula II as defined above.

According to a further embodiment of the invention is provided a chromatographic method comprising
(a) providing a column packed with a chromatographic stationary phase comprising a solid support, ⊕, having bonded thereto at least one silyl group according to Formula I as defined above and at least one silyl group according to Formula II as defined above;
(b) providing a carrier phase;
(c) passing the carrier phase through the column; and
(d) injecting the mixture into the carrier phase at a point prior to the carrier phase entering the column;
wherein the carrier phase is capable of eluting at least one species contained in the sample through the column.

Additional aspects, advantages and novel features of embodiments of the invention will be set forth in part in the Description, and the Examples which follow, all of which are intended to be for illustrative purposes only, and not intended in any way to limit the invention, and in part, will become apparent to those skilled in the art on examination of the following, or may be learned by practice of the invention.

### DETAILED DESCRIPTION

A. Definitions

The term “alkyl”, by itself, or as part of another substituent, e.g., cyanooalkyl or aminoalkyl, means a hydrocarbyl group, which is a saturated hydrocarbon radical having the number of carbon atoms designated (i.e., C₁-C₆ alkyl means the group contains one, two, three, four, five or six carbon atoms) and includes straight, branched chain, cyclic and polycyclic groups. Examples include: methyl, ethyl, propyl, isopropyl, butyl, isobutyl, tert-butyl, pentyl, neopentyl, hexyl, cyclohexyl, decyl, dodecyl, tetradecyl, octadecyl, norbornyl, and cyclopropylmethyl. Alkyl groups include, for example, —(C₁-C₄₀)alkyl, —(C₁-C₆)alkyl, —(C₃-C₂₀) alkyl and —(C₆-C₄₀)cycloalkyl.

The term “saturated,” with respect to an alkyl group means that all of the carbon-carbon bonds in the alkyl group are carbon-carbon single bonds.

The term “hydrocarbyl” refers to any moiety comprising only hydrogen and carbon atoms. Hydrocarbyl groups include saturated, e.g., alkyl groups, unsaturated groups, e.g., alkenes and alkynes, aromatic groups, e.g., phenyl and naphthyl and mixtures thereof. Hydrocarbyl groups include, for example, (C₁-C₄₀)hydrocarbyl, (C₆-C₄₀)hydrocarbyl, and —(C₆-C₄₀)alkyl.

The term “alkylene,” by itself or as part of another substituent, means a saturated hydrocarbylene radical. For example, the expression “—C(═O)(C₁-C₄)alkylene-R” may include, for example, one, two, three and four carbon alkylene groups. A substitution of a group, such as R on alkylene, may be at any substitutable carbon. For example, the group, —C(═O)(C₄ alkylene)R, includes, for example (a), (b) and (c), in Scheme 1, below:

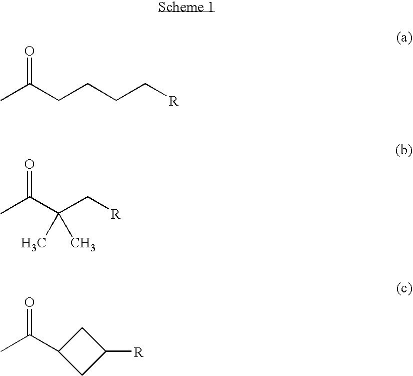

The term “hydrocarbylene” by itself or as part of another substituent means a divalent straight, branched or cyclic chain hydrocarbon radical having the designated number of carbons. For example, the expression “—C(═O)(C₁-C₄)hydrocarbylene-R” includes one-, two-, three- and four-carbon divalent hydrocarbon groups. A substitution of a group, such as R, on a hydrocarbylene, may be at any substitutable carbon.

The term “substituted” means that a hydrogen atom attached to a group, e.g., a hydrocarbyl group, has been replaced by another atom, e.g. Cl, or group of atoms, e.g. CH₃. For aryl and heteroaryl groups, the term “substituted” refers to any level of substitution, for example, mono-, di, tri-, tetra-, or penta-substitution. Substituents are independently selected, and substitution may be at any position that is chemically and sterically accessible.

The expression “substituted hydrocarbyl” means hydrocarbyl, as defined above, substituted, for example, by one, two, three or four substituents which may be the same or different. Substituents include, or may be derived from, for example, halogen; —C(halogen)₃, for example —CF₃; —CN; —OH; —NO₂; —O(C₁-C₇)hydrocarbyl; oxo; epoxide; —S(C₁-C₇)hydrocarbyl; —SO(C₁-C₇)hydrocarbyl; —SO₂(C₁-C₇)hydrocarbyl-CO₂(C₁-C₇) hydrocarbyl; a cation exchanger, for example, —CO₂H or —SO₃H; an anion exchanger, for example, —NH₂, —NH(C₁-C₆)alkyl, or —N(C₁-C₆ alkyl)₂; —C(═O)NH₂; —C(═O)NH(C₁-C₇)hydrocarbyl; —C(═O)N((C₁-C₇)hydrocarbyl)₂; urea; peptide; protein; carbohydrate; nucleic acid; and mixtures thereof.

The term “aryl” employed alone or in combination with other terms, means a hydrocarbyl group which is a carbocyclic aromatic group containing one or more rings (typically one, two or three rings), wherein such rings may be attached together in a pendent manner, such as a biphenyl, or may be fused, such as naphthalene. Examples include phenyl, anthracyl and naphthyl.

The term “—(Cᵤ-Cᵥ)alkylene-(Cₓ-C_{y})aryl-” wherein u, v, x and y are integers and u<v and x<y, means a radical wherein a carbon alkylene chain, having from u to v carbon atoms, is attached to an aryl group having from x to y carbon atoms. Examples include, —CH₂CH₂-phenyl, CH₂-phenyl and CH₂-naphthyl. Alkylene groups for “—(Cᵤ-Cᵥ)alkylene-(Cₓ-C_{y})aryl-” include, for example, —CH₂—, —CH₂CH₂— and —CH(CH₃)—. The term “substituted —(Cᵤ-Cᵥ)alkyl-(Cₓ-C_{y})aryl-” means a group as defined above in which the aryl group is substituted.

The term “cycloalkyl” refers to ring-containing alkyl radicals. Cycloalkyl groups may contain, for example, 1, 2 or 3 rings. For cycloalkyl groups containing more than one ring, i.e., polycyclic cycloalkyl groups, the rings may be fused, i.e., two rings share two or more adjacent ring atoms and the bonds connecting the two or more shared ring atoms, spiro-fused, i.e., two rings share one ring atom, or the rings may be connected in a pendent manner, i.e. one atom of one ring is bonded to one atom of a second ring, wherein the connecting bond may be a single bond or a double bond. Examples of a fused ring sharing two ring atoms (a), a fused ring sharing more than two ring atoms (b), a spiro-fused ring (c) and rings connected in a pendant manner (d) are depicted in Scheme 2.

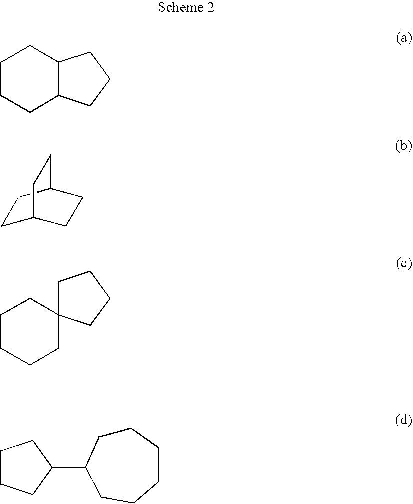

Examples of cycloalkyl groups include cyclohexyl, cycloheptyl, cyclooctyl, cyclododecyl, cyclooctylethyl, norbornyl, decahydronaphthyl and tetradecahydroanthryl.

The expression, “reactive chemical group” refers to a chemical group in a compound which group is, for example, nucleophilic or electrophilic, or a substrate for electrophilic addition reaction, such that the reactive chemical group is the chemical group directly involved in bond making or bond breaking in a chemical reaction of the compound. Examples of nucleophilic reactive chemical groups include primary and secondary amino groups, alcohol —OH groups, and thiol —SH groups. Examples of electrophilic reactive chemical groups include leaving groups. An example of a group that is a substrate for electrophilic addition is an olefin group such as a vinyl group.

The expression “leaving group” refers to the chemical group that is displaced in a substitution or elimination reaction. Examples include halogen atoms, such as —Cl and —Br, and sulfonate moieties, such as mesyl, tosyl, nosyl, and trifyl.

The term “metal” refers to an element that is lustrous, ductile and generally electropositive, i.e., forms compounds in positive oxidation states, and that is a conductor of heat and electricity as a result of having an incompletely filled valence shell. The term, “metal oxide” refers to a chemical compound of oxygen with a metal, for example, tin oxide. The term “metal oxide” is inclusive of metal oxides that have been treated so as to provide particular functional groups on the surface of the metal oxide.

The term “metalloid” refers to an element, for example zirconium, or silicon which demonstrates properties which are intermediate between the properties of typical metals and typical nonmetals, i.e., has physical appearance and properties of a metal (as defined above), but behaves chemically as a non-metal. Elements classified as metalloids are in the periodic table in a diagonal block separating metals from nonmetals, and include, for example silicon, boron, arsenic, bismuth, germanium, antimony, and tellurium. The term, “metalloid oxide” refers to a chemical compound of oxygen with a metalloid, for example, silicon dioxide. The term “metalloid oxide” is inclusive of metalloid oxides that have been treated so as to provide particular functional groups on the surface of the metalloid oxide, for example, Si—OH, Si—H or Si—Cl groups.

B. Silyl Groups of Formulae I and II

In silyl groups of Formulae I or II, X may be, for example, —(C₁-C₆)alkyl.

According to an embodiment of the invention, one of R¹ and R² is other than an unsubstituted straight chain alkyl group. According to another embodiment, both R¹ and R² are other than an unsubstituted straight chain alkyl group. According to another embodiment, either R¹ or R² is other than a substituted or unsubstituted straight chain alkyl group. According to another embodiment, both R¹ and R² are other than a substituted or unsubstituted straight chain alkyl group. According to another embodiment, one of R¹ and R² is other than unsubstituted —(C₆-C₄₀)hydrocarbyl.

R¹ or R² may independently comprise, for example, a C₁-C₂₀ straight chain alkyl group to which is bonded at least one cyclohexyl group, for example, one, two three or four cyclohexyl groups, wherein the at least one cyclohexyl group is optionally substituted by one or two substituents which are —(C₁-C₄)alkyl and which substituents may be the same or different.

According an embodiment of the invention, R¹ or R² independently comprise, for example, a substituted or unsubstituted (C₆-C₁₄) aryl group or a (C₆-C₄₀) cyclic alkyl group, which cyclic alkyl group may be a monocyclic alkyl group or a polycyclic alkyl group;

A cyclic alkyl R¹ or R² group may be selected, for example, from the group consisting of cyclohexyl, cycloheptyl, cyclooctyl, cyclononyl, cyclodecyl, cyclododecyl, cyclotetradecyl, cyclooctadecyl, bicyclo[2.2.2]octyl, bicyclo-[2.2.1]heptyl, 4-t-butylcyclohexyl, 3,5-dimethylcyclohexyl, cyclohexylmethyl, 2-cyclohexylethyl, 2,2-dicyclohexylethyl, 4-(cyclohexyl)cyclohexyl, 4-((4-cyclohexyl)cyclohexyl)cyclohexyl, 1-decahydronaphthyl, 2-decahydronaphthyl, 1-tetradecahydroanthryl, 2-tetradecahydroanthryl, 10-tetradecahydroanthryl, octahydro-1H-indenyl, 4-cyclohexylidenecyclohexyl and 4,4-(spiro-cyclohexyl)cyclohexyl.

R¹ or R² groups that are substituted —(C₃-C₄₀)hydrocarbyl may be, for example, mono-, di- or tri-substituted.

Substituents on substituted —(C₃-C₄₀)hydrocarbyl R¹ or R² groups may be independently selected, for example, from the group consisting of halogen, for example, —F, —Cl and —Br; —CN; —OH; —NO₂; —O(C₁-C₇)hydrocarbyl, for example, —O(C₁-C₆)alkyl or —O-benzyl; oxo; epoxide; —SO₂(C₁-C₇)hydrocarbyl, for example, —SO₂(C₁-C₆)alkyl or —SO₂-benzyl, —SO(C₁-C₇)hydrocarbyl, for example, —SO(C₁-C₆)alkyl or —SO-benzyl, —S(C₁-C₇)hydrocarbyl, for example, —S(C₁-C₆)alkyl or —S-benzyl, —CO₂(C₁-C₇) hydrocarbyl, for example, —CO₂(C₁-C₆)alkyl or —CO₂-benzyl; a anion exchanger, for example, —CO₂H or —SO₃H; an cation exchanger, for example —NH₂, —NH(C₁-C₆)alkyl, —N(C₁-C₆ alkyl)₂ or —N⁺((C₁-C₅)alkyl)₃; —C(═O)NH₂; —C(═O)NH(C₁-C₇)hydrocarbyl, for example, —C(═O)NH(C₁-C₆)alkyl or —C(═O)NHbenzyl; —C(═O)N((C₁-C₇)hydrocarbyl)₂, for example, —C(═O)N((C₁-C₆)alkyl)₂ or —C(═O)N(C₁-C₆alkyl)benzyl; urea containing moieties; peptide radicals; and mixtures thereof.

Urea substituents on substituted (C₃-C₄₀)hydrocarbyl R¹ or R² groups may be independently selected, for example, from the group consisting of —NHC(═O)NH₂, —N(C₁-C₇)hydrocarbylC(═O)NH₂, —NHC(═O)NH(C₁-C₇)hydrocarbyl, —NHC(═O)N(C₁-C₇)₂hydrocarbyl, —N(C₁-C₇)₂hydrocarbylC(═O) NH(C₁-C₇)hydrocarbyl, and —N(C₁-C₇)₂hydrocarbylC(═O)N(C₁-C₇)₂hydrocarbyl.

In silyl groups of Formulae I and II, R^{a} may be, for example, unsubstituted —(C₄-C₁₈)alkyl, or substituted —(C₂-C₅)alkyl, or substituted or unsubstituted —(C₁-C₄)alkylene-phenyl.

A —(C₄-C₂₀) alkyl R^{a} group may be, for example, mono-, di- or tri-substituted.

Substituents on substituted —(C₄-C₂₀) alkyl R^{a} groups may be, for example, independently selected from the group consisting of halogen, for example, —F, —Cl and —Br; —CN; —OH; —NO₂; —O(C₁-C₇)hydrocarbyl, for example, —O(C₁-C₆)alkyl or —O-benzyl; a cation exchanger, for example, —CO₂H or —SO₃H; an anion exchanger, for example, —NH₂, —NH(C₁-C₆)alkyl, —N((C₁-C₆)alkyl)₂, —N⁺((C₁-C₆)alkyl)₃; and mixtures thereof.

Substituted —(C₁-C₄)alkylene-(C₆-C₁₀)aryl R^{a} may be, for example, mono-, di- or tri-substituted.

Substituents on substituted —(C₁-C₄)alkylene-(C₆-C₁₀)aryl R^{a} may be, for example, independently selected from the group consisting of halogen, for example, —F, —Cl and —Br; —CN; —OH; —NO₂; —O(C₁-C₇)hydrocarbyl, for example, —O(C₁-C₆)alkyl or —O-benzyl; a cation exchanger, for example, —CO₂H or —SO₃H; an anion exchanger, for example, —NH₂, —NH(C₁-C₆)alkyl, —N((C₁-C₆)alkyl)₂, —N⁺((C₁-C₆)alkyl)₃; and mixtures thereof.

The group —(C₂-C₅)alkylene-OC(═O)NR^{a}R^{b} may be selected, for example, from (a)-(l) below:

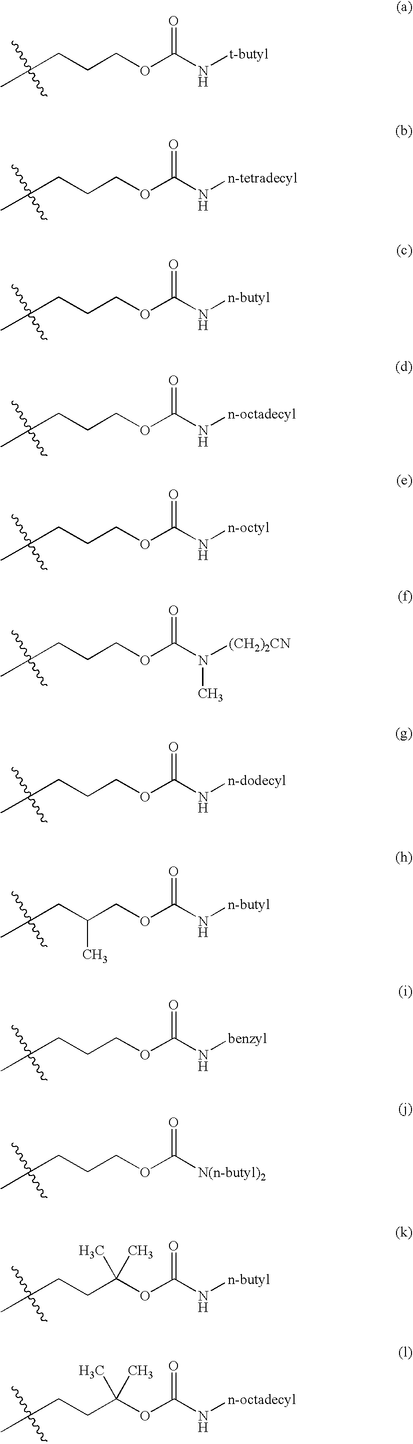

R^{b} may be, for example, —H or methyl.

According to an embodiment of the invention, R² is a —(C₂-C₅)alkylene-OC(═O)NR^{a}R^{b} group, R^{a} is -(n-C₈H₁₇) or -(n-C₁₄H₂₉), and R^{b} is —H.

When R^{a} and R^{b} are combined to form a ring, the ring comprises, for example, a 5-, 6-, 7-, 8- or 9-membered ring. Structures (i), (ii), (iii), or (iv), below are examples of groups wherein R^{a} and R^{b} are combined to form a ring.

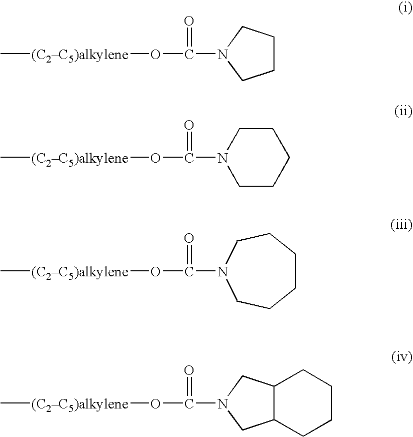

The following are exemplary combinations of silyl moieties bonded to the substrate, ⊕, that are within the scope of the current invention.

The silyl moiety according to Formula I may be, for example, a sulfopropyldimethylsilyl moiety, and the silyl group according to Formula II may be selected, for example, from the group consisting of phenylyldimethylsilyl, octyldimethylsilyl, hexyldimethylsilyl, cyclohexyldimethylsilyl, glycidoxypropyldimethylsilyl and 2,3-dihydroxypropoxypropyldimethylsilyl.

The silyl moiety according to Formula I may be, for example, octadecyldimethylsilane, and the silyl moiety according to Formula II may be selected, for example, from the group consisting of phenylyldimethylsilyl, octyldimethylsilyl, hexyldimethylsilyl, cyclohexyldimethylsilyl, cyanopropyldimethylsilyl, propyldimethylsilyl, aminopropyldimethylsilyl, carboxypropyldimethylsilyl, sulfopropyldimethylsilyl, glycidoxypropyldimethylsilyl and 2,3-dihydroxypropoxypropyldimethylsilyl.

The silyl moiety according to Formula I may be, for example, a cyanopropyldimethylsilyl group, and the silyl moiety according to Formula II may be selected, for example, from the group consisting of phenylyldimethylsilyl, octyldimethylsilyl, hexyldimethylsilyl, cyclohexyldimethylsilyl, aminopropyldimethylsilyl, carboxypropyldimethylsilyl, sulfopropyldimethylsilyl, glycidoxypropyldimethylsilyl and 2,3-dihydroxypropoxypropyldimethylsilyl.

The silyl moiety according to Formula I may be, for example, an aminopropyldimethylsilyl group, and the silyl moiety according to Formula II may be selected, for example, from the group consisting of phenyldimethylsilyl, octyldimethylsilyl, hexyldimethylsilyl, cyclohexyldimethylsilyl, cyanopropyldimethylsilyl, carboxypropyldimethylsilyl, sulfopropyldimethylsilyl, glycidoxypropyldimethylsilyl and 2,3-dihydroxypropoxypropyldimethylsilyl.

The silyl moiety according to Formula I may be, for example, a carboxypropyldimethylsilyl group, and the silyl moiety according to Formula II may be selected, for example, from the group consisting of phenylyldimethylsilyl, octyldimethylsilyl, hexyldimethylsilyl, cyclohexyldimethylsilyl, cyanopropyldimethylsilyl, sulfopropyldimethylsilyl, glycidoxypropyldimethylsilyl and 2,3-dihydroxypropoxypropyldimethylsilyl.

The silyl moiety according to Formula I may be, for example, a cyanopropyldimethylsilyl, and the silyl moiety according to Formula II may be selected, for example, from the group consisting of phenylyldimethylsilyl, octyldimethylsilyl, hexyldimethylsilyl, cyclohexyldimethylsilyl, sulfopropyldimethylsilyl, glycidoxypropyldimethylsilyl and 2,3-dihydroxypropoxypropyldimethylsilyl.

The silyl moiety according to Formula I may be, for example, a —(C₂-C₅)alkylene-OC(═O)NR^{a}R^{b}, wherein R^{a} and R^{b} are as defined herein, and the silyl moiety according to Formula II may be selected, for example, from the group consisting of phenylyldimethylsilyl, octyldimethylsilyl, hexyldimethylsilyl, butyldimethylsilyl, propyldimethylsilyl, cyclohexyldimethylsilyl, cyclotetradecyldimethylsilyl, cyclooctadecyldimethylsilyl, cyanopropyldimethylsilyl, propyldimethylsilyl, aminopropyldimethylsilyl, carboxypropyldimethylsilyl, sulfopropyldimethylsilyl, glycidoxypropyldimethylsilyl and 2,3-dihydroxypropoxypropyldimethylsilyl.

C. The Substrate

Substrates useful in embodiments of the invention have a surface comprising chemical groups that are capable of reacting with a surface modifying reagent. For example, metalloid oxides, such as silica or alumina, may be suitably chemically prepared, e.g., by hydrolysis, such that surface —OH groups are provided for reaction with a surface modifying reagent, for example, a silane reagent comprising a leaving group, for example a Si—Cl group.

The substrate surface may alternatively be derivatized to provide chemical groups other than an —OH group, which groups are reactive toward surface-modifying silane reagents that have a reactive moiety other than a leaving group. For example, the surface of silica substrate may be halogenated with a halogenating reagent, e.g., a chlorinating agent, for example, silicon tetrachloride or thionyl chloride. The resulting halogenated substrate surface, containing reactive Si—X groups, wherein X is a halogen, may then be reacted with silane reagents containing, for example, Si—OH groups to prepare the stationary phase compositions according to an embodiment of the invention.

The silica surface may alternatively be derivatized to provide —Si—H groups. Such Si—H groups may be reacted, for example, with an olefin, such as a vinyl group in a hydrosilation reaction.

The substrate comprises, for example, a material selected from the group consisting of silica, hybrid silica, zirconia, titania, chromia, alumina and tin oxide. Hybrid silicas include materials where a portion of the Si atoms, or SiO groups have been replaced by other metal or metalloid atoms, such as W, Mg, Al, Zr, B or Ge. Alternatively, in hybrid silica, a portion of the Si—O bonds have been replaced by other moieties, such as hydrocarbyl or O-hydrocarbyl groups, hydrogen or other species, such as phosphorous. For example, a hybrid silica may include a fraction having the formula Si—O—Si—Y—Si—O or Si—OSi(Y)—O, where Y represents a metal, metalloid, hydrocarbyl or other species. According in some embodiments of the invention the substrate comprises silica.

According to an embodiment of the invention, a substrate comprises particles of the metal oxide or metalloid oxide, for example, particles of silica. The substrate particles may comprise, for example, microspheres, for example, silica microspheres.

For the practice of embodiments of the invention, for use as chromatography substrates, microspheres, such as silica microspheres, may have an average diameter ranging from about 0.5 to about 50 microns, or alternatively, from about 1 to about 30 microns, or alternatively, from about 1 to about 15 microns. The expression “average diameter” means the statistical average of the spherical diameters of the microspheres.

Microspheres, such as silica microspheres, useful as substrates in the practice of embodiments of the invention may be porous or non-porous. Porous microspheres may have controlled pore dimensions and a relatively large pore volume. According to an embodiment of the invention, the microspheres may be a hybrid such as silica/zirconia, silica/titania or silica/alumina for example.

The size and shape of substrates useful in the practice of embodiments of the invention are variable. According to an embodiment of the invention, a substrate may comprise a solid material coated with a layer of a suitable metal oxide or metalloid oxide, for example, silica, which is capable of reacting with a suitable silane reagent. The substrate may be in the form of different shapes, such as spheres, irregularly shaped articles, rods, plates, films, sheets, fibers, or other massive irregularly shaped objects. For example, titania may be coated with a thin layer of silica, for example according to the method described by Iber. See, Iber, “The Chemistry of Silica,” John Wiley and Sons, New York, 1979, p. 86; the entire disclosure of which is incorporated herein by reference. This layer of silica may be prepared, e.g., by hydrolysis, and reacted with a suitable silane reagent.

When the compositions disclosed herein are used in chromatography, the composition may be, for example, packed in a chromatography column or deposited onto a chromatography plate.

D. Preparation of Compositions

The preparation of stationary phase compositions by reaction of a individual silanes with a substrate is known. A general discussion of the reaction of individual silanes with the surface of silica-based support materials is provided in “An Introduction to Modem Liquid Chromatography,” L. R. Snyder and J. J. Kirkland, Chapter 7, John Wiley and Sons, NY, N.Y. (1979) the entire disclosure of which is incorporated herein by reference. The reaction of individual silanes with porous silica is disclosed in “Porous Silica,” K. K. Unger, p. 108, Elsevier Scientific Publishing Co., NY, N.Y. (1979) the entire disclosure of which is incorporated herein by reference. A description of reactions of individual silanes with a variety of support materials is provided in “Chemistry and Technology of Silicones,” W. Noll, Academic Press, NY, N.Y. (1968) the entire disclosure of which is incorporated herein by reference.

The reactive group L may be, for example, a leaving group. When L is a leaving group, L may be independently selected, for example, from the group consisting of halogen, for example, —F, —Cl and —Br; —O(C₁-C₆)alkyl, for example, —OCH₃ and —OC₂H₅; and —N((C₁-C₃)alkyl)₂, for example —N(CH₃)₂ and —N(C₂H₅)₂.

The silane reagent, such as octadecyldimethylsilylchloride, which has one leaving group, i.e. the —Cl leaving group, reacts to bond to the substrate, ⊕, as shown in Scheme 3.

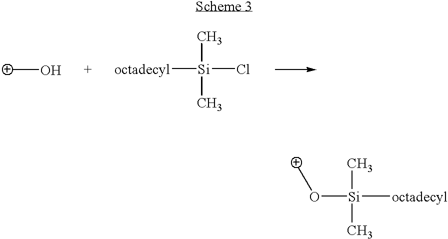

The process, according to an embodiment of the present invention, of preparing a stationary phase composition may comprise a single step reaction of a mixture of one or more silanes of Formula III and one or more silanes of Formula IV with a suitable substrate. Typically, the reaction may be performed in a suitable organic solvent or solvent mixture, for example, toluene, xylene, or mesitylene or a mixture thereof. The reaction may, for example, be performed at an elevated temperature, for example, from about 50° C. up to the reflux temperature of the solvent or solvent mixture. The relative amounts of each of the silanes which are incorporated into the prepared stationary phase composition may be controlled, for example by controlling the ratio of the different silanes of Formulae III and IV that are added to the reaction.

Silanes of Formulae III and IV may be used in a process according to an embodiment of the invention in any proportion from about 1% of III and 99% of IV to about 99% III and 1% IV, based on the total amount of silane reagents according to Formulae III and IV in the liquid medium. Thus, processes for preparing a stationary phase composition according to an embodiment of the invention comprise mixtures of reagents of Formulae III and IV which may be in a molar ratio of Formula III silanes to Formula IV silanes of, for example, 1%-99%, 5% to 95%, 10% to 90%, 15% to 85%, 20% to 80%, 25% to 75%, 30% to 70%, 35% to 65%; 40% to 60%, 45% to 55%, 50% to 50%, 55% to 45%, 60% to 40%, 65% to 35%, 70% to 30%, 75% to 25%, 80% to 20%, 85% to 15%, 90% to 10%, 95%-5% or 99% to 1%.

The relative amounts of each of the silyl groups which are incorporated into the prepared stationary phase composition may also be influenced by differences in reactivity of the different silane reagents of Formulae III and IV. Such differences in reactivity may result due to the presence of different R¹, R² or X groups on the silane, for example due to steric bulk. Reactivity of silanes that contain a particular R¹ and X groups or R² and X groups, may also be modulated by selection of the reactive chemical group L.

Novel compositions according to embodiments of the present invention may alternatively be prepared by a multi-step reaction, wherein the substrate may be reacted sequentially with different single silane reagents according to Formulae III and IV. Typically, each of the sequential reactions may be performed in a suitable organic solvent or solvent mixture, for example, toluene, xylene, or mesitylene and mixtures thereof. Each reaction is typically performed at an elevated temperature, for example, from about 50° C. up to the reflux temperature of the solvent or solvent mixture. The sequential reactions with different silane reagents may be performed with or without isolation of the intermediate product after each of the sequential reactions. The relative amounts of each of the silanes which are incorporated into the prepared stationary phase composition may be controlled by controlling the amount of each reagent that is incorporated into the substrate during each of the sequential steps. The amount of each reagent that is incorporated into the substrate during a reaction may be controlled, for example, by controlling the stoichiometry of the reaction, by controlling the reaction conditions, such as reaction time, reaction temperature and concentration of reagents, i.e. by using either an excess or deficit of the calculated stoichiometric amount. The amount of each reagent incorporated may also be controlled by selection of silane reagent of Formulae III or IV having a suitable reactive moiety -L, or by selection of any combination factors affecting the amount of the silane reagent incorporated into the substrate. When a multi-step preparation is used, the reaction conditions, such as stoichiometry, may be suitably restricted to limit the incorporation of the silyl group for all but the last silane reagent to be reacted. For the last silane to be reacted, the reaction conditions, such as stoichiometry, may be suitably controlled to react as much as possible of the remaining reactive groups on the substrate surface. The appropriate reaction conditions for each silane and combination of silanes may be readily ascertained through routine experimentation.

For example, the first silane reagent to be reacted with the substrate may be reacted, for example, in an amount that is calculated to form covalent bonds to a limited percentage, for example 5%, 10%, 15%, 20%, 25%, 30%, 35%, 40%, 45%, 50%, 55%, 60%, 65%, 70%, 75%, 80%, 85%, 90%, or 95%, of the reactive groups, for example silanol groups, that are available on the substrate surface. For example, in the case of fully hydroxylated silica surfaces, about 8 micromol/m² of potentially reactive silanol groups are present on the surface. The number of available silanol groups is one factor that may be considered in calculating reaction stoichiometry. Another factor which may affect the reaction is the variable steric effect associated with different R¹, R² and X groups in the silanes of Formulae III and IV employed in the preparation of compositions according to an embodiment of the invention. For larger and/or more sterically demanding silanes, fewer of the total available silanol groups may physically be reacted. Even for a smaller silane reactant, all of these silanol groups may not be reacted. For example, for chlorotriisopropylsilane reacted individually with a silane substrate, it has been estimated that about 1.3 micromol/m² of silane can be covalently bonded to the substrate surface. See, U.S. Pat. No. 4,705,725, the entire contents of which are incorporated herein by reference. For sterically larger silanes, even lower maximum numbers of the available silanol groups may effectively react to form covalent bonds with the silane.

The product composition obtained from either the single step or the multi-step preparation may optionally further be reacted with an end-capping reagent. The end-capping reagent may be a relatively small silane reagent, for example, LSiR^{e}₃, wherein L is a reactive chemical group such as a —Cl leaving group; and R^{e} is a —(C₁-C₄) alkyl group. The endcapping reagent serves to react with reactive groups on the substrate surface, e.g., silanol groups on a silica substrate, that remain unreacted with a silane according to Formula III or IV after the reaction therewith is completed.

Compositions according to embodiments of the invention comprise a silyl group according to Formula I in any proportion from about 1% up to about 99% based on the total amount of silyl groups according to Formulae I and II which are bonded to the composition according to embodiments of the invention. Likewise, compositions according to embodiments of the invention comprise a silyl group according to Formula II in any proportion from about 1% up to about 99% based on the total amount of silyl groups according to Formulae I and II which are bonded to the composition according to embodiments the invention. Thus, compositions according to embodiments of the invention comprise silyl groups having a molar ratio of Formula I silyl groups to Formula II silyl groups of, for example, 1% to 99%, 5% to 95%, 10% to 90%, 15% to 85%, 20% to 80%, 25% to 75%, 30% to 70%, 35% to 65%; 40% to 60%, 45% to 55%, 50% to 50%, 55% to 45%, 60% to 40%, 65% to 35%, 70% to 30%, 75% to 25%, 80% to 20%, 85% to 15%, 90% to 10%, 95%-5%, or 99% to 1%.

E. Chromatography Tools Containing the Composition

The composition according to embodiments of the present invention may be employed in methods of separating chemical species by chromatography. For use in chromatography, the composition according to embodiments of the invention, in a particulate form, may be, for example, packed into a chromatography column for industrial, analytical or preparatory equipment. Chromatography columns are produced in a variety of dimensions, which are based on the application that the particular column is used for. According to an embodiment of the invention, column dimension may be from about 0.1 to about 21.2 mm in diameter and from about 5 mm to about 250 mm in length. According to an embodiment of the invention column diameters may be from about 0.1 mm to about 9.4 mm. According to an embodiment of the invention column diameters may be from about 0.1 mm to about 4.6 mm. According to an embodiment of the invention column lengths may range from 5 mm to 250 mm. According to an embodiment of the invention column lengths may range from 20 mm to 150 mm. The chromatography column containing a composition according to an embodiment of the invention may be operably connected to a reservoir containing a suitable carrier phase, and to a pump, for example, a mechanical or syringe pump, capable of pumping the carrier phase through the chromatography column, and to an injector capable of introducing one or more chemical species into the chromatography column. According to an embodiment of the invention the carrier phase may be pumped through the column at a rate of from about 0.1 mL/min. to about 20 mL/min. According to an embodiment of the invention, flow rates may range from 0.5 mL/min. to 5 mL/min., or 5 mL/min to 20 mL/min. According to an embodiment of the invention flow rates may also range from 1 mL/min. to 2 mL/min., or from 10 mL/min to 15 mL/min. The chromatography column containing a composition according to an embodiment of the invention may further be operably connected to a detector, for example, an ultraviolet spectrophotometer, capable of detecting and optionally analyzing separated chemical species that are eluted from the chromatography column. The chromatography column containing a composition according to an embodiment of the invention may further be operably connected to a fraction collector capable of collecting the carrier phase containing separated species in a plurality of separate containers such that the separated species may be handled separately.

The composition according to an embodiment of the invention, in a particulate form, may alternately be deposited onto a chromatography plate, e.g., a thin layer chromatography plate or preparative thin layer chromatography plate. A chromatography plate comprises a layer of a material, for example, glass or a polymer film, on which is deposited a chromatographic stationary phase composition.

A chromatography plate containing a composition according to an embodiment of the invention may be operably connected to a reservoir of a suitable mobile phase and to an injector capable of introducing chemical species onto the chromatography plate.

The composition according to an embodiment of the invention may alternately be employed in solid phase extraction (SPE) processes. For use in SPE processes, compositions according to an embodiment of the invention may be provided, for example, in an SPE cartridge. The expression “solid phase extraction cartridge” is understood to include housings of various shapes, sizes and configurations which contain one or more stationary phase compositions according to an embodiment of the invention. SPE cartridges thus include, for example, cylindrical columns and disks. SPE cartridges include cartridges that are designed as disposable units and cartridges designed for repeated use. SPE cartridges include single cartridges and arrays of cartridges, for example ninety-six well plates. Passage of a carrier phase through a SPE cartridge may be performed, for example by employing a solvent pump to push the carrier phase through the SPE cartridge, or by application of vacuum to pull the carrier phase through the cartridge. The stationary phase compositions according to an embodiment of the invention, provided in a SPE cartridge, may be provided in amounts, for example from about 25 mg to about 100 g per cartridge.

The instrumentation and techniques for using compositions according to embodiments of the invention for chromatographic separations, including high performance liquid chromatography (HPLC), thin layer chromatography (TLC), flash chromatography, solid phase extraction and other forms of chromatographic separation can be understood and employed by those skilled in the art.

The practice of embodiments of the invention is illustrated by the following non-limiting examples.

### EXAMPLES

General Procedure:

Step A: Preparation of a Silica Substrate

Porous silica particles (13 g, 5 micron diameter, 80 Å pore size) are obtained from Agilent Technologies, Inc. (Palo Alto Calif.). The silica particles are then treated according to the method of J. J. Kirkland and J. Kohler U.S. Pat. No. 4,874,518, the entire disclosure of which is incorporated herein by reference, to yield a fully hydroxylated surface, as follows.

The silica is heated at 850° C. for 3 days and then allowed to cool to ambient temperature (about 25° C.). The resulting material is suspended in 130 mL of water containing 200 ppm of HF. The suspension is boiled for 3 days, then allowed to cool to ambient temperature (about 25° C.). The cooled suspension is then filtered through an extra-fine fritted disk. The collected silica is washed with 2000 mL of deionized water. The silica is rinsed with acetone and dried at 120° C. and 0.1 mbar (0.01 kPa) for 15 hours. The dried silica is then rinsed successively with 300 mL of a water/ammonium hydroxide-solution (pH=9), rinsed with water to neutrality, and 100 mL of acetone and then dried at 0.1 mbar and 120° C. for 15 hours. The dried silica is kept in a dry nitrogen atmosphere until needed.

Step B: Preparation of a Stationary Phase Composition

To ten grams of dried silica, prepared as in Step A, is added 50 mL of dry toluene under nitrogen. To this mixture is added 1.2 equivalents of pyridine, a first silane reagent according to a calculated stoichiometry, and a second silane reagent according to a calculated stoichiometry, wherein the stoichiometry is based on the calculated number of reactive silanol groups on the dried treated silica. The resulting mixture is heated at reflux temperature 110° C. for 24 hours, and then cooled to ambient temperature (about 25° C.). The product is collected by filtration The collected product is washed with 250 mL each of toluene, tetrahydrofuran, methanol and acetone and is then dried overnight (0.1 mbar, 110° C.).

### Example 1

### Preparation of a stationary phase composition comprising 20% octadecyldimethylsilyl groups and 80% —Si(CH₃)₂—(CH₂)₃OC(═O)NH-(n-C₁₄H₂₉) groups on the silica substrate

The stationary phase composition is prepared according to General Procedure 1, Step B. The silane reagents are: 0.2 equivalents of octadecyldimethylchlorosilane, and 0.8 equivalents of Cl—Si(CH₃)₂13 (CH₂)₃OC(═O)NH-(n-C₁₄H₂₉)

### Example 2

### Preparation of a stationary phase composition comprising 40% octadecyldimethylsilyl groups and 60% —Si(CH₃)₂—(CH₂)₃OC(═O)NH-(n-C₁₄H₂₉) groups on the silica substrate

The stationary phase composition is prepared according to General Procedure 1, Step B. The silane reagents are: 0.4 equivalents of octadecyldimethylchlorosilane, and 0.6 equivalents of Cl—Si(CH₃)₂—(CH₂)₃OC(═O)NH-(n-C₁₄H₂₉)

### Example 3

### Preparation of a stationary phase composition comprising 60% octadecyldimethylsilyl groups and 40% —Si(CH₃)₂—(CH₂)₃OC(═O)NH-(n-C₁₄H₂₉) groups on the silica substrate

The stationary phase composition is prepared according to General Procedure 1, Step B. The silane reagents are: 0.6 equivalents of octadecyldimethylchlorosilane, and 0.4 equivalents of Cl—Si(CH₃)₂—(CH₂)₃OC(═O)NH-(n-C₁₄H₂₉)

### Example 4

### Preparation of a stationary phase composition comprising 80% octadecyldimethylsilyl groups and 20% —Si(CH₃)₂—(CH₂)₃OC(═O)NH-(n-C₁₄H₂₉) groups on the silica substrate

The stationary phase composition is prepared according to General Procedure 1, Step B. The silane reagents are: 0.8 equivalents of octadecyldimethylchlorosilane, and 0.2 equivalents of Cl—Si(CH₃)₂—(CH₂)₃OC(═O)NH-(n-C₁₄H₂₉).

### Example 5

### Preparation of a stationary phase composition comprising 20% octadecyldimethylsilyl groups and 80% —Si(CH₃)₂—(CH₂)₃OC(═O)NH-(n-C₈H₁₇) groups on the silica substrate

The stationary phase composition is prepared according to General Procedure 1, Step B. The silane reagents are: 0.2 equivalents of octadecyldimethylchlorosilane, and 0.8 equivalents of Cl—Si(CH₃)₂—(CH₂)₃OC(═O)NH-(n-C₈H₁₇).

### Example 6

### Preparation of a stationary phase composition comprising 40% octadecyldimethylsilyl groups and 60% —Si(CH₃)₂—(CH₂)₃OC(═O)NH-(n-C₈H₁₇) groups on the silica substrate

The stationary phase composition is prepared according to General Procedure 1, Step B. The silane reagents are: 0.4 equivalents of octadecyldimethylchlorosilane, and 0.6 equivalents of Cl—Si(CH₃)₂—(CH₂)₃OC(═O)NH-(n-C₈H₁₇).

### Example 7

### Preparation of a stationary phase composition comprising 60% octadecyldimethylsilyl groups and 40% —Si(CH₃)₂—(CH₂)₃OC(═O)NH-(n-C₈H₁₇) groups on the silica substrate

The stationary phase composition is prepared according to General Procedure 1, Step B. The silane reagents are: 0.6 equivalents of octadecyldimethylchlorosilane, and 0.4 equivalents of Cl—Si(CH₃)₂—(CH₂)₃OC(═O)NH-(n-C₈H₁₇).

### Example 8

### Preparation of a stationary phase composition comprising 80% octadecyldimethylsilyl groups and 20% —Si(CH₃)₂—(CH₂)₃OC(═O)NH-(n-C₈H₁₇) groups on the silica substrate

The stationary phase composition is prepared according to General Procedure 1, Step B. The silane reagents are: 0.8 equivalents of octadecyldimethylchlorosilane, and 0.2 equivalents of Cl—Si(CH₃)₂—(CH₂)₃OC(═O)NH-(n-C₈H₁₇).

The present invention may be embodied in other specific forms without departing from the spirit or essential attributes thereof. Accordingly, reference should be made to the appended claims, rather than to the foregoing specification, as indication of the scope of the invention.

What is claimed is:

1. A composition comprising a solid support, ⊕, having covalently bonded thereto at least one silyl moiety according to Formula I:
—O—Si(R¹)ₙ(X¹)ₘ Formula I
and at least one different silyl moiety according to Formula II:
—O—Si(R²)ₙ(X²)ₘ Formula II
wherein:
X¹ and X² are independently —(C₁-C₆)alkyl;
—O—Si represents an oxygen bond between a silyl moiety and the solid support;
n is 1;
m is 2; and
R¹ and R² are independently selected from the group consisting of substituted —(C₃-C₄₀)hydrocarbyl and unsubstituted —(C₆-C₄₀)hydrocarbyl, and —(C₂-C₅)alkylene-OC(═O)NR^{a}R^{b}; wherein
R^{a} is substituted or unsubstituted —(C₄-C₂₀)alkyl or substituted or unsubstituted —(C₁-C₄)alkylene-(C₆-C₁₀)aryl; and
R^{b} is —H or —(C₁-C₅)alkyl;
wherein the expression —(C₂-C₅)alkylene-OC(═O)NR^{a}R^{b} includes moieties wherein R^{a} and R^{b} are combined to form a ring inclusive of the nitrogen atom bound to R^{a} and R^{b}.

2. The composition according to claim 1, wherein the molar ratio of the silyl moiety of Formula I to the silyl moiety of Formula II in the composition is from 1:99to99:1.

3. The composition according to claim 1, wherein X¹ and X² are both —CH₃.

4. The composition according to claim 1, further comprising an end-capping group bonded to the solid support.

5. The composition according to claim 4, wherein X¹ and X² are both —CH₃.

6. The composition according to claim 1 wherein R² comprises a C₁-C₂₀ straight chain alkyl group to which is bonded at least one cyclohexyl group, wherein the cyclohexyl group is optionally substituted by one or two substituents which are —(C₁-C₄)alkyl and which are the same or different.

7. The composition according to claim 1 wherein R² comprises a (C₆-C₄₀) cyclic alkyl group.

8. The composition according to claim 7 wherein the cyclic alkyl group is selected from the group consisting of cyclohexyl, cycloheptyl, cyclooctyl, cyclononyl, cyclodecyl, cyclododecyl, cyclotetradecyl, cyclooctadecyl, bicyclo[2.2.2]octyl, bicyclo[2.2.1]heptyl, 4-t-butylcyclohexyl, 3,5-dimethylcyclohexyl, cyclohexylmethyl, 2-cyclohexylethyl, 2,2-dicyclohexylethyl, 4-(cyclohexyl)cyclohexyl, 4-((4-cyclohexyl)cyclohexyl)cyclohexyl, 1-decahydronaphthyl, 2-decahydronaphthyl, 1-tetradecahydroanthryl, 2-tetradecahydroanthryl, 10-tetradecahydroanthryl, octahydro-1H-indenyl, 4-cyclohexylidenecyclohexyl and 4,4-(spiro-cyclohexyl)cyclohexyl.

9. The composition according to claim 1 wherein R¹ is unsubstituted —(C₃-C₄₀)hydrocarbyl and R² is a —(C₂-C₅)alkylene-OC(═O)NR^{a}R^{b} group.

10. The composition according to claim 9 wherein R² is —(CH₂)₃OC(═O)NH-(n-C₁₄H₂₉) or —(CH₂)₃OC(═O)NH-(n-C₈H₁₇).

11. The composition according to claim 1 wherein the substrate comprises a material selected from the group consisting of silica, hybrid silica, zirconia, titania, alumina, chromia and tin oxide.

12. The composition according to claim 11 wherein the substrate is a particulate.

13. The composition according to claim 12 wherein the particulate substrate comprises silica.

14. The composition according to claim 9, wherein —(C₂-C₅)alkylene-OC(═O)NR^{a}R^{b} is selected from the group consisting of:

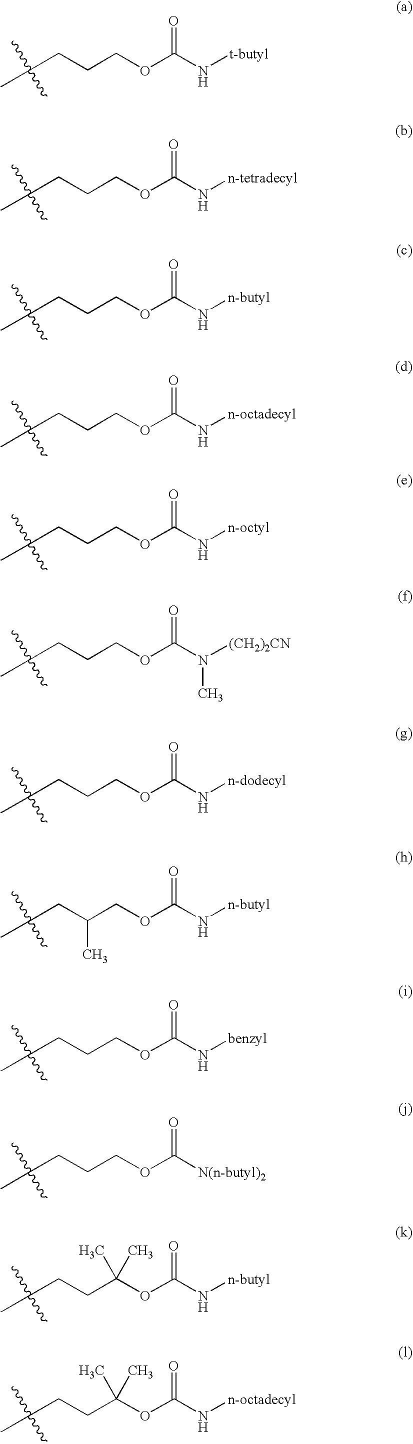

15. A chromatography column containing a stationary phase comprising the composition according to claim 1.

16. A chromatography column containing a stationary phase comprising the composition according to claim 14.

17. A solid phase extraction cartridge containing a stationary phase comprising the composition according to claim 1.

18. A chromatography plate containing a stationary phase comprising the composition according to claim 1.

19. The composition according to claim 1, wherein at least one of R¹ and R² is substituted with a substituent selected from the group consisting of: halogen, —CN, —OH, —NO₂, —O(C₁-C₇)hydrocarbyl, oxo, epoxide, —SO₂(C₁-C₇)hydrocarbyl, —SO(C₁-C₇)hydrocarbyl, —S(C₁-C₇)hydrocarbyl, —CO₂(C₁-C₇) hydrocarbyl, an anion exchanger, a cation exchanger, —C(═O)NH₂, —C(═O)NH(C₁-C₇)hydrocarbyl, —C(═O)N(C₁-C₇)₂hydrocarbyl, urea containing moieties, peptide radicals, and mixtures thereof.

20. A method for producing a composition according to claim 1, comprising:
reacting a solid support, ⊕, having reactive silanol groups thereon with with a first silane compound according to Formula III:
Si(R¹)ₙ(X¹)ₘ(L)_{g} Formula III
and a second silane compound according to Formula IV:
Si(R²)_{n′}(X²)_{m′}(L)_{g} Formula IV
wherein:
X¹ and X² are independently —(C₁-C₆)alkyl;
R¹ and R² are independently selected from the group consisting of substituted —(C₃-C₄₀) hydrocarbyl and unsubstituted —(C₆-C₄₀) hydrocarbyl, and —(C₂₋C₅)alkylene-OC(═O)NR^{a}R^{b}; wherein
R^{a} is substituted or unsubstituted —(C₄-C₂₀)alkyl or substituted or unsubstituted —(C₁-C₄)alkylene-(C₆-C₁₀)aryl; and
R^{b} is —H or —(C₁-C₅)alkyl;
wherein the expression —(C₂-C₅)alkylene-OC(═O)NR^{a}R^{b} includes moieties wherein R^{a} and R^{b} are combined to form a ring inclusive of the nitrogen atom bound to R^{a} and R^{b}; and
L is a reactive chemical group;
n is 1;
m is 2; and
g is 1.

21. The method according to claim 20, wherein the solid support is reacted with the first silane and the second silane together in a single step.

22. The method according to claim 20, wherein the solid support is reacted with the first silane and the second silane in separate sequential steps.

23. The method according to claim 20 further comprising, reacting the solid support with an end-capping reagent.

24. A method of performing a chromatographic separation of a plurality of chemical species in a mixture, comprising:
(a) providing a composition comprising a solid support, ⊕, having covalently bonded thereto at least one silyl moiety according to Formula I:
—O—Si(R¹)ₙ(X¹)ₘ Formula I
and at least one different silyl moiety according to Formula II:
—O—Si(R²)ₙ(X²)ₘ Formula II
wherein:
X¹ and X² are independently —(C₁-C₆)alkyl;
—O—Si represents an oxygen bond between a silyl moiety and the solid support;
n is 1;
m is 2; and
R¹ and R² are independently selected from the group consisting of substituted —(C₃-C₄₀)hydrocarbyl and unsubstituted —(C₆-C₄₀)hydrocarbyl, and
